(19) United States
(12) Patent Application Publication
(10) Pub. No.: US 2015/0303552 A1
(43) Pub. Date: Oct. 22, 2015

(54) COMMUNICATION DEVICE ANTENNA

(71) Applicant: KING SLIDE TECHNOLOGY CO.,LTD., Kaohsiung City (TW)

(72) Inventors: Hsin-Cheng Su, Kaohsiung City (TW); Chun-Ta Liu, Kaohsiung City (TW); Shu-Chen Lin, Kaohsiung City (TW)

(73) Assignee: KING SLIDE TECHNOLOGY CO.,LTD., Kaohsiung City (TW)

(21) Appl. No.: 14/253,880

(22) Filed: Apr. 16, 2014

(51) Int. Cl. H01Q 1/24

(52) U.S. Cl. CPC H01Q 1/243

(57) ABSTRACT

The present invention relates to a communication device antenna including a metal housing and an excitation component. The metal housing has a first lateral side, a second lateral side and a connection side extended and connected between the first lateral side and the second lateral side. An opening is formed and located adjacent to the connection side. A coupling gap is defined between the excitation component and the connection side of the metal housing. The excitation component is connected to the signal feed point and the ground point. The excitation component is configured to perform electromagnetic energy excitation, such that the metal housing can be utilized as a radiation unit.

### BACKGROUND OF THE INVENTION

1. Field of the Invention

The present invention relates to a communication device antenna, and more particularly, to a metal housing being utilized as an antenna of a communication device, for emitting and receiving radio signals of the communication device.

2. Description of the Prior Art

During product development processes of conventional communication devices, such as mobile communication products, plastic housings are mainly used by manufacturers due to cost concerns, in order to maintain basic radiation characteristics of an antenna. However, a trend of metal housing is currently brought by Apple iPhones and Macbooks. Since the metal housing has light weight, good heat dissipation, high strength, high impact resistance, good looking, anti-electromagnetic and recyclable characteristics, the metal housing is getting more and more popular. Therefore, the metal housings are mainly used in development of new generations of the mobile communication products. For example, U.S. Pat. No. 8,054,231 B2 disclosed by Ahn et al. teaches a metal case having a slot, which can be used as a slot antenna of a mobile device. But the slot may obviously ruin appearance of the metal case, and the slot needs to be arranged at a position corresponding to a specific area of the metal case. Therefore, it is important to design a proper antenna to allow electromagnetic waves to penetrate the metal case for achieving communication purposes without obviously ruining the appearance of the metal case.

### SUMMARY OF THE INVENTION

It is therefore an objective of the claimed invention to provide a communication device antenna in order to utilize a metal housing as an antenna, for emitting and receiving radio signals of a communication device.

According to an embodiment of the present invention, a communication device antenna comprises a metal housing, a signal feed point, a ground point and an excitation component. The metal housing has a first lateral side, a second lateral side corresponding to the first lateral side, and a connection side extended and connected between the first lateral side and the second lateral side, wherein an opening is formed and located adjacent to the connection side. The excitation component is connected to the signal feed point and the ground point, wherein a coupling gap is defined between the excitation component and the connection side of the metal housing.

Preferably, the excitation component comprises a first metal part, a second metal part, a third metal part, a fourth metal part and a fifth metal part, wherein the first metal part is connected to the signal feed point, the second metal part is connected to the ground point, the third metal part is located adjacent to the connection side of the metal housing, the fourth metal part is extended and connected between the first metal part and the third metal part, and the fifth metal part is extended and connected between the second metal part and the third metal part.

Preferably, the opening comprises a first slit and a second slit, the second slit is substantially perpendicular to the first slit, the first slit is formed straight along the adjacent connection side of the metal housing, and the second slit is located adjacent to the second lateral side of the metal housing.

Preferably, the first slit and the second slit together form an L-shaped opening.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram showing arrangement of a communication device according to an embodiment of the present invention.

FIG. 2 is a diagram showing opening arrangement of the communication device according to the embodiment of the present invention.

FIG. 3 is a diagram showing antenna arrangement of the communication device according to the embodiment of the present invention.

FIG. 4 is an enlarged view of an area A in FIG. 3.

### DETAILED DESCRIPTION

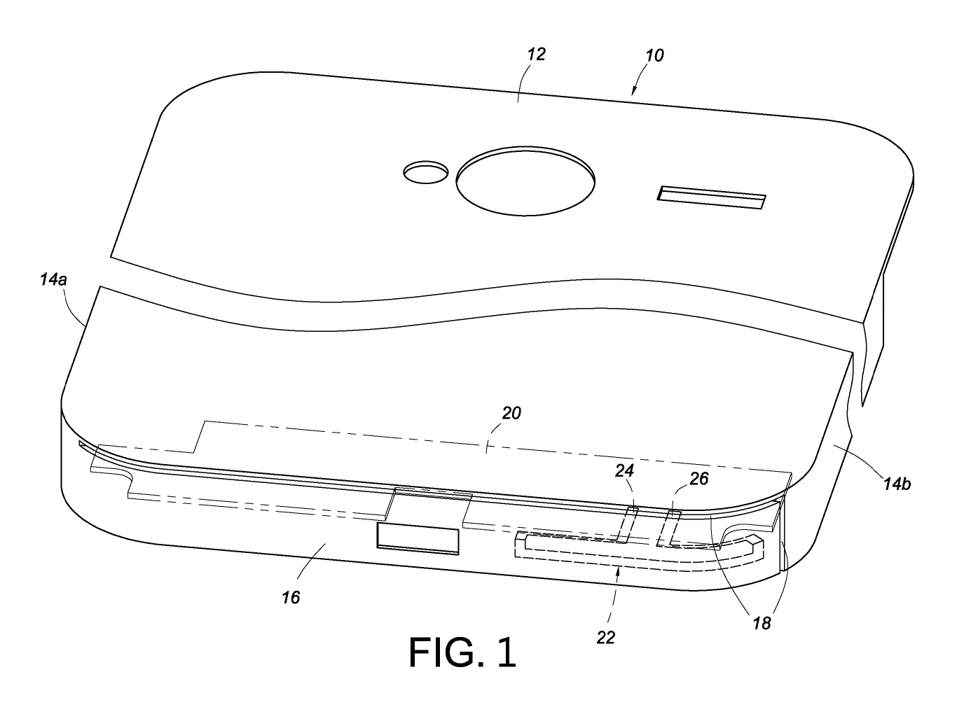

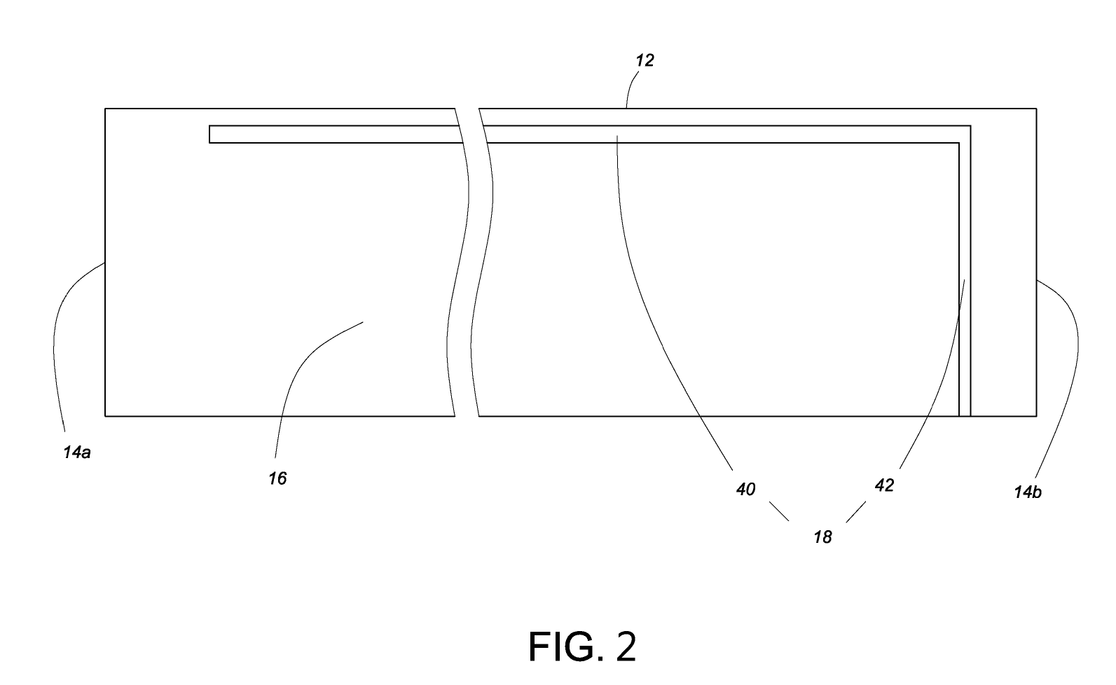

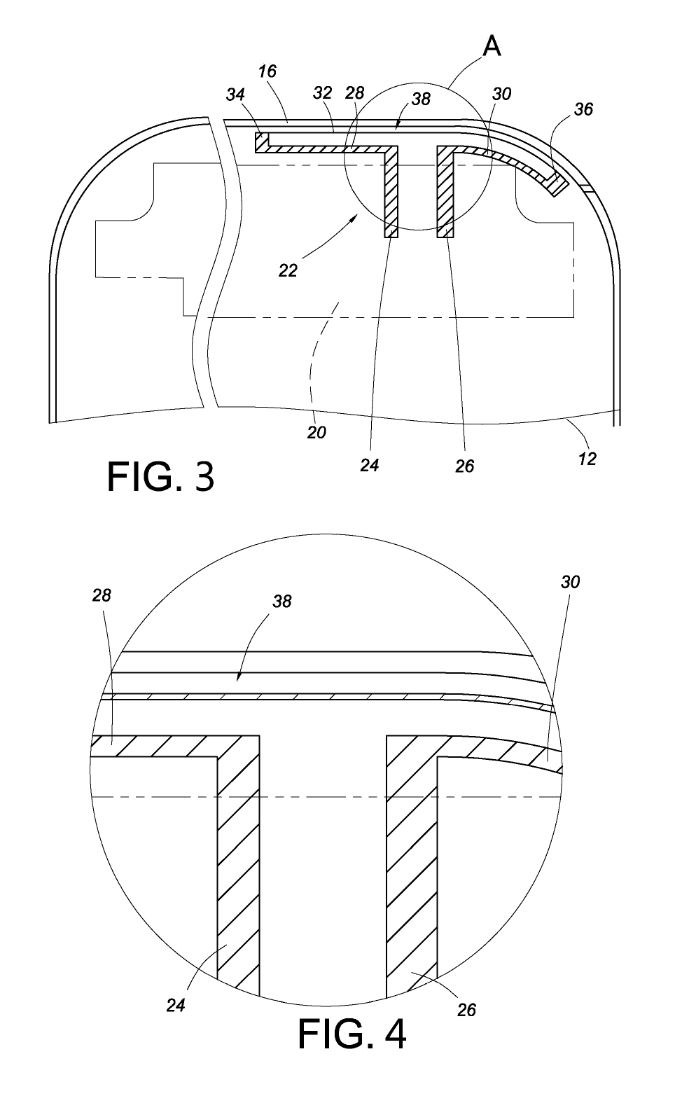

FIG. 1 to FIG. 4 are diagrams showing a communication device 10 having a metal housing 12 according to an embodiment of the present invention. The metal housing 12 has a first lateral side 14a, a second lateral side 14b located at a position corresponding to the first lateral side 14a, and a connection side 16 extended and connected between the first lateral side 14a and the second lateral side 14b.

Antenna arrangement of the communication device 10 comprises at least a printed circuit board 20 and an excitation component 22, wherein the printed circuit board 20 comprises a signal feed point 24 and a ground point 26. Please note that the printed circuit board 20 can be arranged in other size relative to the communication device 10. In other words, the size of the printed circuit board 20 is not limited by the figures.

The excitation component 22 comprises a first metal part 28, a second metal part 30, a third metal part 32, a fourth metal part 34 and a fifth metal part 36, wherein the first metal part 28 is connected to the signal feed point 24 of the printed circuit board; the second metal part 30 is connected to the ground point 26 of the printed circuit board 20; the third metal part 32 is located adjacent to the connection side 16 of the metal housing 12, and a coupling gap 38 is defined between the third metal part 32 and the connection side 16 of the metal housing 12. In a preferred embodiment, the fourth metal part is substantially extended and connected between the first metal part 28 and the third metal part 32 perpendicularly, and the fifth metal part 36 is substantially extended and connected between the second metal part 30 and the third metal part 32 perpendicularly.

The first metal part 28, the second metal part 30, the third metal part 32, the fourth metal part 34 and the fifth metal part 36 of the excitation component 22 form an approximate circular path.

In a preferred embodiment, an opening 18 is formed and located adjacent to the connection side 16 of the metal housing 12. The opening 18 comprises a first slit 40 and a second slit 42 substantially perpendicular to the first slit 40, wherein the first slit 40 is formed straight along the adjacent connection side 16 of the metal housing 12, and the second slit 42 is located adjacent to the second lateral side 14b of the metal housing 12. In a preferred embodiment, the first slit 40 and the second slit 42 together form an L-shaped opening, but the opening 18 is not limited by the shape and arrangement disclosed in the embodiment of the present invention.

According to the above arrangement, when the communication device 10 is turned on, power at the signal feed point 24 of the printed circuit board 20 is fed into the excitation component 22, and the power is further coupled to the connection side 16 of the metal housing 12 through the coupling gap 38, such that the metal housing 12, especially the connection side 16 of the metal housing 12 can be utilized as a radiating strip, for transmitting and receiving radio signals of the communication device 10. Therefore, the excitation component 22 can work as a feeding strip for performing electromagnetic energy excitation. Please note that arrangement of the excitation component 22 in the figures is one of preferred embodiments, the present invention can utilize other types of excitation components for performing electromagnetic energy excitation.

According to the above illustration, efficacies and advantages of the present invention are listed as follows:
a. appearance of the metal housing is not obviously ruined, and in contrast to the prior art, the metal housing has better appearance; and
b. the antenna is arranged at an edge of the metal housing, and in contrast to the prior art, the antenna occupies less space.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A communication device antenna, comprising:
a metal housing having a first lateral side, a second lateral side corresponding to the first lateral side, and a connection side extended and connected between the first lateral side and the second lateral side, wherein an opening is formed and located adjacent to the connection side;
a signal feed point;
a ground point; and
an excitation component connected to the signal feed point and the ground point, wherein a coupling gap is defined between the excitation component and the connection side of the metal housing.

2. The communication device antenna of claim 1, wherein the excitation component comprises a first metal part, a second metal part, a third metal part, a fourth metal part and a fifth metal part; wherein the first metal part is connected to the signal feed point, the second metal part is connected to the ground point, the third metal part is located adjacent to the connection side of the metal housing, the fourth metal part is extended and connected between the first metal part and the third metal part, and the fifth metal part is extended and connected between the second metal part and the third metal part.

3. The communication device antenna of claim 1, wherein the opening comprises a first slit and a second slit, the second slit is substantially perpendicular to the first slit, the first slit is formed straight along the adjacent connection side of the metal housing, and the second slit is located adjacent to the second lateral side of the metal housing.

4. The communication device antenna of claim 3, wherein the first slit and the second slit together form an L-shaped opening.
